(19) United States
(12) Patent Application Publication
(10) Pub. No.: US 2004/0059801 A1
(43) Pub. Date: Mar. 25, 2004

(54) Method and apparatus for implementing access control on web-based configuration pages using SNMP-based mechanism

(75) Inventors: Gregory N. Nakanishi, San Diego, CA (US); Gordon B. Beacham, San Diego, CA (US); Richard DiBenedetto, San Diego, CA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/252,249

(22) Filed: Sep. 23, 2002

(51) Int. Cl. G06F 15/177

(52) U.S. Cl. 709/220

(57) ABSTRACT

A method enables user configuration of one or more feature parameters of a cable modem using a web page but permits a service operator to control this user configuration by specifying which of the one or more feature parameters a user can configure and/or view. According to an exemplary embodiment of the method, a web server executes an access control function prior to presenting a web page to a user to determine which of the one or more feature parameters are permitted to be viewed/configured by the user. Each configuration field on the web page is associated with an object identifier corresponding to a feature parameter defined in a feature management information base. For each of the one or more feature parameter object identifiers the access control function determines an appropriate access level to use by searching for an access policy that matches the object identifier associated with the configuration field on the web page. If found, the access control function returns one of several possible access levels to the web server associated with the configuration field.

### FIELD OF THE INVENTION

The present invention is directed to methods and apparatuses for remotely interacting with a cable modem, and more particularly to a method and apparatus for remotely interacting with a cable modem to enable user configuration of certain parameters that affect operations of the cable modem.

### BACKGROUND

As cable modems continue to evolve, additional features beyond those specified in the Data Over Cable Service Interface Specification (DOCSIS) (e.g., gateway, wireless interface) are being integrated into the cable modems. These features typically require a number of parameters to be configured in order for proper operation. Service providers, in this case, Multiple Services Operators (MSOs), want the flexibility of being able to configure these parameters on behalf of the user or to permit the user to perform the configuration on their own. Often, this is done remotely.

MSOs manage the cable modem configuration remotely through the use of Simple Network Management Protocol (SNMP), whereas user configuration is generally accomplished using a web browser. This necessitates some type of access control function that can be: (1) managed by the service provider through SNMP for defining the features that the user is allowed to configure; and (2) linked with the web server to enforce the access policies set by the service provider.

Two common approaches currently exist for the management of configuration parameters, neither of which fully addresses the issues described above. The first approach is to manage configuration exclusively through SNMP using the access control features of the SNMP framework. This allows a service provider to control which features a user is allowed to configure; however, the user must use SNMP to perform the configuration. The access control functions of SNMP will enforce the access policies set by the service provider. A web browser cannot be used to perform the configuration because there is no inherent interface between the web server and the SNMP access control function.

The second approach is to split the responsibility of configuring feature parameters between the service provider and the user. The service provider through SNMP configures a set of features and the user through a web browser configures a different set of features. Thus, the service provider does not have the flexibility in specifying which features the user will be allowed to configure. This is fixed by the design of the product and cannot be changed.

The present invention is therefore directed to the problem of developing a method and apparatus for enabling a user and/or a service provider to configure operational parameters of a cable modem remotely while providing the service provider control over which operational parameters a user may configure.

### SUMMARY OF THE INVENTION

The present invention solves these and other problems by providing inter alia an access control function that is configurable through SNMP and is linked to the web server. This provides the service provider flexibility in determining which features a user is permitted to configure through a web browser. The access control function enables the service provider to define access policies that specify the user configurable features. The web server consults the access function to dynamically determine which features the user is allowed to configure and display the appropriate web pages.

The present invention is also very flexible and extensible. The approach is flexible because it allows each service provider to define their own set of features that they will manage or allocate management control to the user. The approach is extensible because it allows new features to be added as the product evolves. Any new features and associated configuration parameters added to the product in the future can be controlled via a Delegation Management Information Database (MIB). An MIB is an acronym for a database of objects, with attributes and values, representing the manageable components of a network device.

According to one aspect of the present invention, the Access Control Function may be implemented as a single function call to the Delegation MIB lookup procedure for all the parameters on a Graphical User Interface (GUI) page. This approach would require a variable list of parameters to be passed to the Access Control Function for each page. One alternative is to make multiple Access Control Function calls to the Delegation MIB lookup procedure, one function call for each parameter on a GUI page. Many of the advanced GUI pages contain several configuration parameters and a function call to determine access control for each parameter may result in reduced performance or a noticeable delay to the GUI user.

### BRIEF DESCRIPTION OF THE DRAWINGS

FIG. 1 depicts a flow chart of an exemplary embodiment of a method according to a first aspect of the present invention.

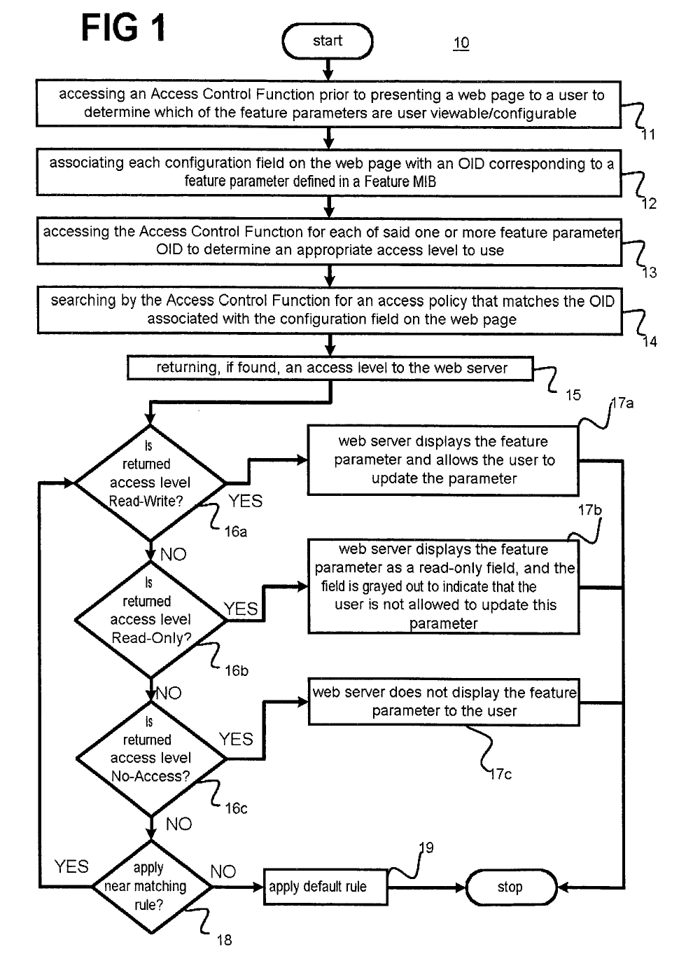

FIG. 2 depicts a logical diagram of the architecture of an exemplary embodiment of a management module according to another aspect of the present invention.

FIG. 3 depicts a block diagram of an exemplary embodiment of an apparatus for performing the method set forth in claim 1 according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

One aspect of the present invention provides an overall configuration management architecture for cable modems, e.g., Motorola cable modem gateway products. An overview of the overall architecture is first provided, followed by specific details on the components of the architecture for which the present invention applies.

Traditionally, the management of the configuration information in a Data Over Cable Service Interface Specification (DOCSIS) compliant cable modem was entirely done by the service provider (e.g., the cable operator). SNMP is the primary method used by the service provider to manage the cable modem. While the user was able to view some of the configuration information, the user was not allowed to modify any configuration parameters. Some non-DOCSIS value added features in the cable modem (e.g., wireless interface, gateway, router, firewall, VPN end-point, print server) require parameters to be configured for the feature to properly function. The user through a web browser usually performs the configuration of these value-added features. With this management model, the service provider does not have the ability to control the configuration of non-DOCSIS features.

The architecture of the present invention supports the following capabilities:

1. The service provider can manage feature configuration parameters through SNMP.

2. The service provider may delegate the configuration of select feature parameters to the user.

3. The user can configure select feature parameters through a web browser, but only those feature parameters that are permitted by the service provider.

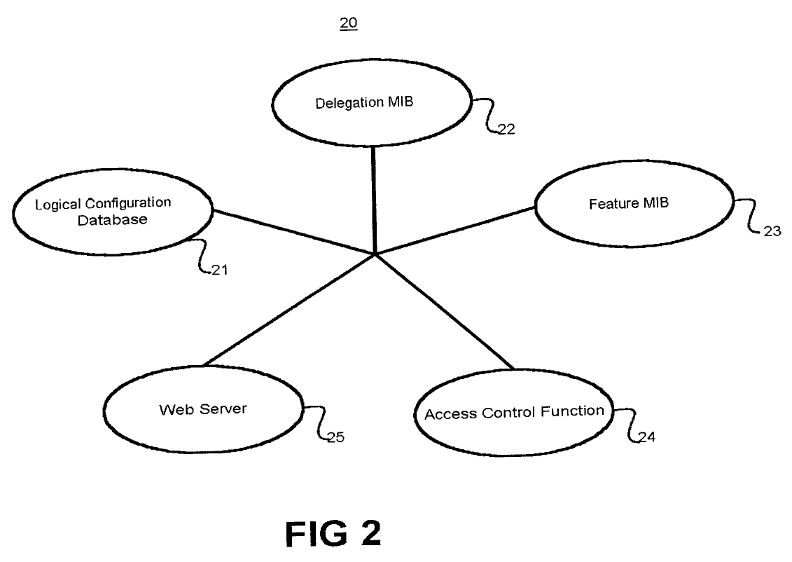

A logical representation of the management architecture is shown in FIG. 2, which depicts a Management Module 20 containing the following components:

(1) Delegation Management Information Base (MIB) 22;

(2) Feature MIB 23;

(3) Logical Configuration Database (LCD) 21;

(4) Access Control Function 24; and

(5) Web Server 25.

The Delegation MIB 22 and the interface between the Access Control Function and the Web Server are the two components being addressed herein.

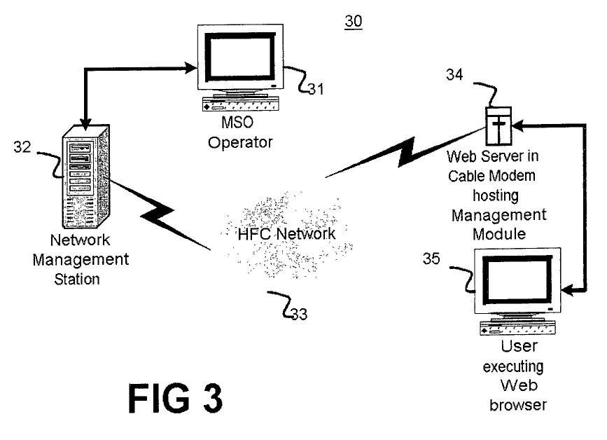

Referring to FIG. 3, the service provider 31 (MSO Operator using a PC or workstation) through a network management station (NMS) 32 interfaces (via the Internet, an Intranet or HFC network 33) to the processor 34 hosting the Management Module using SNMP. Specifically, the NMS 32 uses SNMP to interface with the Delegation MIB 22 and the Feature MIB 23. The Feature MIB 23 is a generic name given to any MIB though which the particular parameters of a feature can be viewed and configured through SNMP. The configuration parameter settings are stored in the Local Configuration Database (LCD) 21. There may be a different MIB for different features. For example, an 802.11 interface may have an associated 802.11 MIB, and a gateway component may have an associated gateway MIB, etc.

The Delegation MIB 22 enables a service provider to specify the feature parameters that the user is allowed to view and/or configure. This is accomplished by specifying an access policy for each feature parameter. The Access Control function maintains the access policies for all feature parameters.

A user, through a web browser executing on a personal computer 35, interfaces with the web server 34 in the cable modem to view/configure feature parameter settings. The web server 34 interfaces with the Access Control Function 24 to determine which feature parameters a user is allowed to view/configure. Based on the access control policies defined by the service provider, the Access Control Function 24 determines which feature parameters settings the web server 34 is permitted to present to the user. Only the allowed feature parameter settings are retrieved from the LCD 21 and presented to the user. If the user is allowed to modify a parameter setting and does so, the update is stored back into the LCD 21.

Delegation MIB Details

The Delegation MIB 22 is the mechanism through which a service provider can specify the feature parameters that a user is allowed to view/configure. The Delegation MIB 22 can be implemented as a standard SNMP MIB module and consists of a single table that has zero or more entries. An entry defines an access policy and has the form <OID, AccessLevel>, where:

OID—An object identifier from the Feature MIB 23. The OID may be fully specified to identify a single feature parameter or may be partially specified to identify a set of feature parameters.

AccessLevel—Defines the access level that the user is allowed to perform on this feature parameter. Values from lowest to highest access level are: Read-Write, Read Only, and No Access.

Web Server Interface to Access Control Module

Prior to presenting a web page to the user, the web server 34 interfaces with the Access Control Function 24 to determine which feature parameters are allowed to be viewed/configured. Each configuration field on the web page is associated with an OID corresponding to a feature parameter defined in the Feature MIB 23. For each feature parameter OID, the web server 34 interfaces with the Access Control Function 24 to determine the appropriate access level to use. The Access Control Function 24 looks for an access policy that matches the OID associated with the configuration field on the web page. If found, one of the following access levels is returned to the web server:

Read-Write—The web server 34 displays the feature parameter and allows the user to update the parameter.

Read-Only—The web server 34 displays the feature parameter as a read-only field. The field is grayed out to indicate that the user is not allowed to update this parameter.

No-Access—The web server 34 does not display the feature parameter to the user.

The matching rules used by the Access Control Function 24 are as follows:

Given the OID of the feature parameter, attempt to find an access policy that exactly matches. If a match is found, apply the access level specified by this entry.

If an exact match is not found, attempt to find an entry that matches the most number of OID sub-identifiers from left to right. E.g., let us say that the feature OID is 1.3.6.1.2.3.4.8 and there are two access policies, <1.3.6.1.2, RW> and >1.3.6.1.2.3, RO>. The access level for the feature parameter would be read-only (RO) since it best matches the second entry.

If there is no matching access policy, the access level is as defined by the Feature MIB. This implies that if the Delegation MIB is empty, the user has full configuration access.

Although various embodiments are specifically illustrated and described herein, it will be appreciated that modifications and variations of the invention are covered by the above teachings and are within the purview of the appended claims without departing from the spirit and intended scope of the invention. Furthermore, these examples should not be interpreted to limit the modifications and variations of the invention covered by the claims but are merely illustrative of possible variations.

What is claimed is:

1. A method for enabling user configuration of one or more feature parameters of a cable modem using a web page comprising:
accessing by a web server an access control function prior to presenting a web page to a user to determine which of said one or more feature parameters are permitted to be viewed/configured by the user;
associating each configuration field on the web page with an object identifier corresponding to a feature parameter defined in a feature management information base;
searching by the access control function for an access policy that matches the object identifier associated with the configuration field on the web page;
returning, if found, one of a plurality of access levels to the web server associated with the configuration field.

2. The method according to claim 1, wherein said plurality of access levels includes one or more of the following: Read-Write access, Read-Only access and No access.

3. The method according to claim 1, wherein one of said plurality of levels includes Read-Write access, which when returned causes the web server to display the feature parameter associated with the configuration field and allows the user to update the parameter.

4. The method according to claim 1, wherein one of said plurality of levels includes Read-Only access, which when returned causes the web server to display the feature parameter as a read-only field.

5. The method according to claim 4, wherein one of said plurality of levels includes Read-Only access, which when returned causes the web server to display the feature parameter as a read-only field, in which the field is grayed out to indicate that the user is not allowed to update this parameter.

6. The method according to claim 1, wherein one of said plurality of levels includes No access, which when returned causes the web server to not display the feature parameter to the user.

7. The method according to claim 1, wherein said searching includes attempting to find an access policy that exactly matches and, if a match is found, applying the access level specified by a matching entry.

8. The method according to claim 1, wherein said searching includes attempting, if an exact match is not found, to find an entry that matches a most number of object identifier sub-identifiers from left to right.

9. The method according to claim 1, wherein said searching includes employing a default level if there is no matching access policy, wherein the default access level is as defined by a Feature management information base.

10. A cable modem comprising:
a management module including a delegation management information base storing access control policies for one or more feature parameters, a feature management information base storing definitions of the one or more feature parameters, an access control function to enforce the stored access control policies for the one or more feature parameters, and a web server to interact with a user's web browser.

11. The cable modem according to claim 11, wherein the web server executes the access control function prior to presenting a web page to a user's browser to determine which of the one or more feature parameters are permitted to be viewed and/or configured by the user.

12. The cable modem according to claim 11, wherein each configuration field on a web page to be presented to a user is associated with an object identifier corresponding to a feature parameter defined in the feature management information database.

13. The method according to claim 12, wherein the access control function determines for each of the one or more feature parameter object identifiers an appropriate access level to use by searching for an access policy that matches the object identifier associated with the configuration field on the web page.

14. The method according to claim 13, wherein if a match is found by the access control function, the access control function returns to the web server one of a plurality of access levels associated with the configuration field.

15. A method for enabling a service provider to control which of one or more feature parameters of a cable modem can be configured by a user comprising:
specifying in a delegation management base in a management module in the cable modem which of the one or more feature parameters the user is allowed to view and/or configure by specifying an access policy for each of the one or more feature parameters; and
enforcing the access policy for each of the specified access policies using an access control function that controls a presentation of the one or more feature parameters to the user when the user attempts to view and/or configure the one or more feature parameter settings.

16. The method according to claim 15, wherein the user interfaces with a web server in the management module through a web browser executing on a personal computer to view and/or configure the one or more feature parameter settings.

17. The method according to claim 15, further comprising accessing by a multiple service operator through a network management station a processor in the cable modem hosting the management module using Simple Network Management Protocol.

18. The method according to claim 17, further comprising storing one or more configuration parameter settings for the one or more feature parameters in a local configuration database in the management module.

19. The method according to claim 18, wherein the access control function interfaces with the web server to determine which of the one or more feature parameters the user is allowed to view and/or configure.

20. The method according to claim 19, wherein the access control function determines which of the one or more feature parameters the user is allowed to view and/or configure based on the access control policies stored in the delegation management base.

21. The method according to claim 20, further comprising retrieving only one or more allowed feature parameter settings from the local configuration database and presenting only the one or more allowed feature parameter settings to the user via the web browser.

22. The method according to claim 21, further comprising storing, if the user is allowed to modify a parameter setting and does so, an update in the location configuration database.
